(19) United States
(12) Patent Application Publication
(10) Pub. No.: US 2011/0159859 A1
(43) Pub. Date: Jun. 30, 2011

(54) METHOD FOR MANAGING COMMUNICATION TRAFFIC OF DEVICES BASED ON AVAILABLE POWER RESOURCES

(76) Inventor: Farrokh Mohammadzadeh Kouchri, Boca Raton, FL (US)

(21) Appl. No.: 13/061,281

(22) PCT Filed: Sep. 15, 2008
(86) PCT No.: PCT/US08/10730

§ 371 Date: Mar. 3, 2011

(51) Int. Cl. H04W 40/10; H04W 4/00

(52) U.S. Cl. 455/415; 455/417

(57) ABSTRACT

The present disclosure is a method and system for managing communication traffic of devices based upon available power for a device. A method for managing communication traffic may include receiving available power resource information from a device and routing communication intended for the device based upon available power of the device.

### TECHNICAL FIELD

The present disclosure generally relates to the field of power monitoring, and more particularly to a method and system for managing communication traffic of devices based upon available power resources.

### BACKGROUND

Mobile telecommunication devices operable across wireless and cellular networks provide a flexible and convenient system for communication. Mobile telecommunication devices typically include a controller, the controller including a processing unit and operating software. Mobile telecommunication devices may use batteries as their source of power. Batteries may be rechargeable or non-rechargeable. Batteries may be the main source of power or may simply be used during power outages.

Current battery-powered telecommunication devices rely upon device-based functions to reduce power consumption when available battery power is below a threshold value. Device-based functions to reduce power consumption may extend an operating time for the telecommunication device to allow a user to continue communication while remaining available and accessible. Device-based functions to reduce power consumption may include disabling backlighting, display and external loudspeaker, reducing processing speed of a processing unit and decreasing audio volume. These device-based functions to reduce power consumption when available power is below a threshold value fail to prevent power failures which disrupt communication.

### SUMMARY

The present disclosure is directed to a method and system for managing communication traffic of devices based upon available power for a device. A method for managing communication traffic may include receiving available power resource information from a device and routing communication intended for the device based upon available power for the device.

A system for managing communication traffic may include a communication network and a receiving device operable within the communication network. A communication network may receive available power information from the receiving device operable within the communication network. Communication network may route communication intended for the receiving device based upon available power information.

It is to be understood that both the foregoing general description and the following detailed description are exemplary and explanatory only and are not restrictive of the disclosure. The accompanying drawings, which are incorporated in and constitute a part of the specification, illustrate an embodiment of the disclosure and together with the general description, serve to explain the principles of the disclosure.

### BRIEF DESCRIPTION OF THE DRAWINGS

The numerous objects and advantages of the present invention may be better understood by those skilled in the art by reference to the accompanying figures in which:

FIG. 1 depicts a flowchart of a method for managing communication traffic of devices based upon available power for a device;

FIG. 2 depicts another flowchart of a method for managing communication traffic of devices based upon available power for a device;

FIG. 3 depicts a block diagram of a system for managing communication traffic based upon available power for a device;

FIG. 4 depicts a block diagram of a device;

FIG. 5 depicts exemplary operation of a system for managing communication traffic based upon available power for a device; and

FIG. 6 depicts exemplary operation of an alternative system for managing communication traffic based upon available power for a device.

### DETAILED DESCRIPTION

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

The detailed description provided below is directed to a method and system for managing communication traffic of devices based upon available power for a device. Additional details of the invention are provided in the examples illustrated in the accompanying drawings.

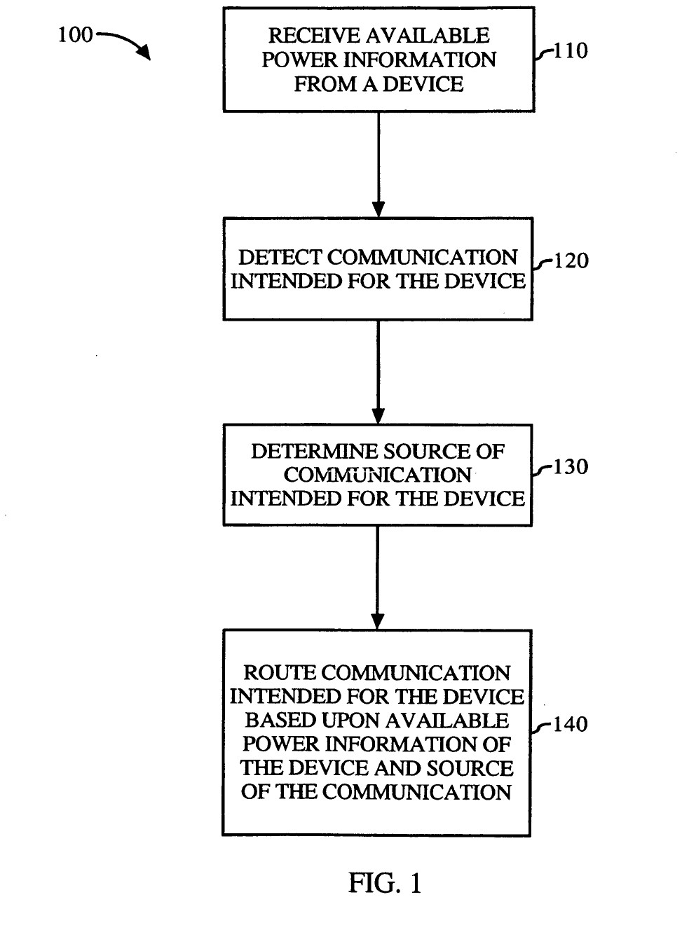

Referring to FIG. 1, a flowchart of a method 100 for managing communication traffic of devices based upon available power for a device is shown. Method 100 may begin upon receiving available power information for a device 110. Available power information may refer to estimated remaining operating time, referred as power to live time. Method 100 may include detecting communication intended for the device 120. Communication may refer to a phone call, electronic mail message, text message and the like that is intended for the device. Method 100 may include determining a source of communication intended for the device 130. For example, determining a source of communication intended for the device may include monitoring a caller identity of the source of communication. Caller identity may refer to the originator's phone number or electronic mail address and the like. Method 100 may further include routing communication based upon available power of the device and the source of the communication. It is contemplated that communication may be routed to the device when the device has available power but may be redirected to a message buffer when the device has low available power depending upon the source of the communication. Message buffer may refer to voicemail and the like.

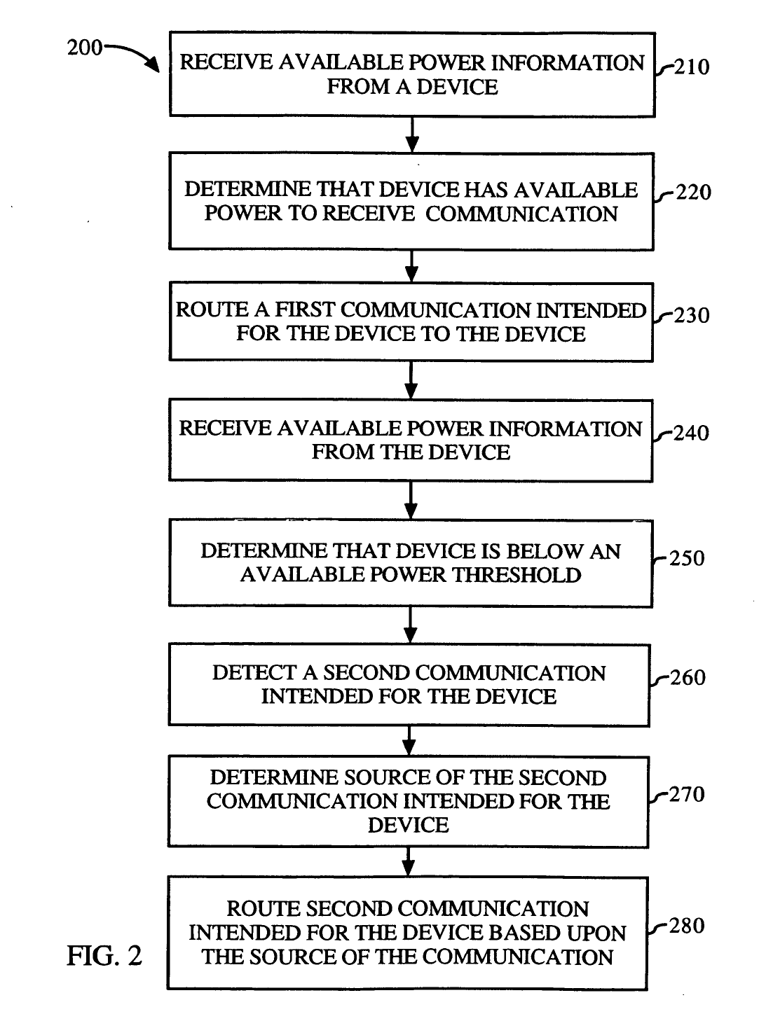

Referring to FIG. 2, another flowchart of a method 200 for managing communication traffic of devices based upon available power for a device is shown. Method 200 may begin upon receiving available power information for a device 210. Available power information may refer to estimated remaining operating time, referred as power to live time. Method 200 may include determining that the device has available power greater than an available power threshold value. This may indicate that the device has available power for receipt of communication intended for the device. Communication may refer to a phone call, electronic mail message, text message and the like that is intended for the device. When a device has available power above a threshold value, each communication intended for the device may be routed to the device 230.

It is contemplated that method may receive multiple instances of available power information of the device. For example, available power information may be received if a change of threshold has occurred. Additionally, available power information may be received according to a random or periodic time schedule. Method 200 may include receiving available power information from the first device 240. Next, method 200 may include determining available power for the device is below an available power threshold 250. When the available power for the first device is below an available power threshold, method may detect communication intended for the device 260. Method 200 may include determining a source of communication intended for the device 270. For example, determining a source of communication intended for the device may include monitoring a caller identity of the source of communication. Caller identity may refer to the originator's phone number or electronic mail address and the like. Method 200 may include routing communication intended for the device based upon the source of the communication 280. For example, a caller identity of a business contact may be intended for a message buffer, such as voice mail where a caller identity of a spouse may be routed to the device.

It is contemplated that available power may be expressed according to a percentage of full power, a voltage, an operating time and the like. Additionally, available power threshold may be expressed according to a percentage of full power, a voltage, an operating time and the like. For example, an available power threshold may be 30 minutes of operating time. If the power capacity of device is 45 minutes operating time, this may be greater than the available power threshold. If the power capacity of device is 15 minutes operating time, this may be less than the available power threshold.

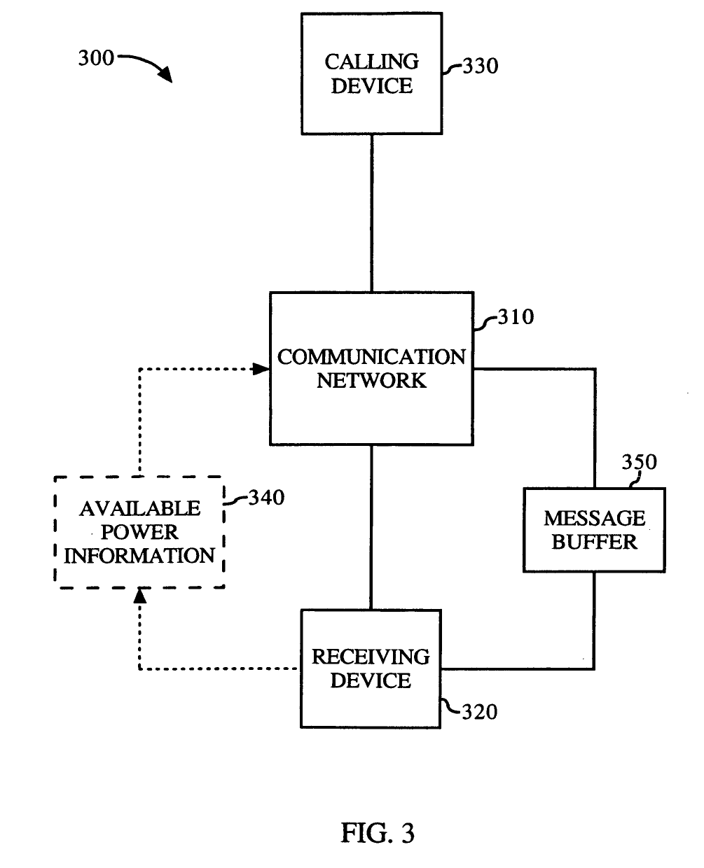

Referring to FIG. 3, a block diagram of a system 300 for managing communication traffic based upon available power for a device is shown. System 300 may include a communication network 310, a receiving device 320 and a calling device 330. Communication network 310 may be configured to receive available power information 340 of the receiving device whereby communication network 310 may manage communication traffic. Communication network 310 may execute methods 100, 200 as shown and described in FIGS. 1-2. Communication network 310 may be an internet telephony network, a cellular network and the like. Communication network may be a mobile telecom system, such as a PUBLIC network or a private network such as WiFi based PBXs. Communication network 310 may be implemented by a cellular service provider. Additionally, communication network 310 may a telecom switch of a voice over Internet Protocol (VoIP). It is contemplated that when receiving device 320 has available power above an available power threshold, communication network may route communication from calling device 330 to receiving device 320. However, communication network 310 may route communication intended for the receiving device 320 to a message buffer, such as voicemail 350, based upon an identity of the calling device 330 when the available power of the receiving device is below an available power threshold.

It is contemplated that a receiving device 320 may register itself with communication network 310. For example, receiving device 320 may designate a particular available power threshold. Receiving device 320 may also designate particular callers from which communication may be routed to receiving device 320 during time periods when receiving device 320 has available power less than the available power threshold. For example, mobile phone numbers of a spouse or child may be listed as caller identities which communication should be passed to the receiving device 320 even at time periods when the available power of the receiving device is below an available power threshold.

It is further contemplated that registration of a desired available power threshold and particular callers which communication may be routed to the receiving device 320 may be cross-referenced with a calendar application. For example, the available power threshold may be adjusted at different times of the day and different days of the week. Additionally, personal contacts may be routed to the receiving device 320 during evening hours of a day while business contacts may be routed to the receiving device 320 during daylight hours of a work week, such as Monday through Friday.

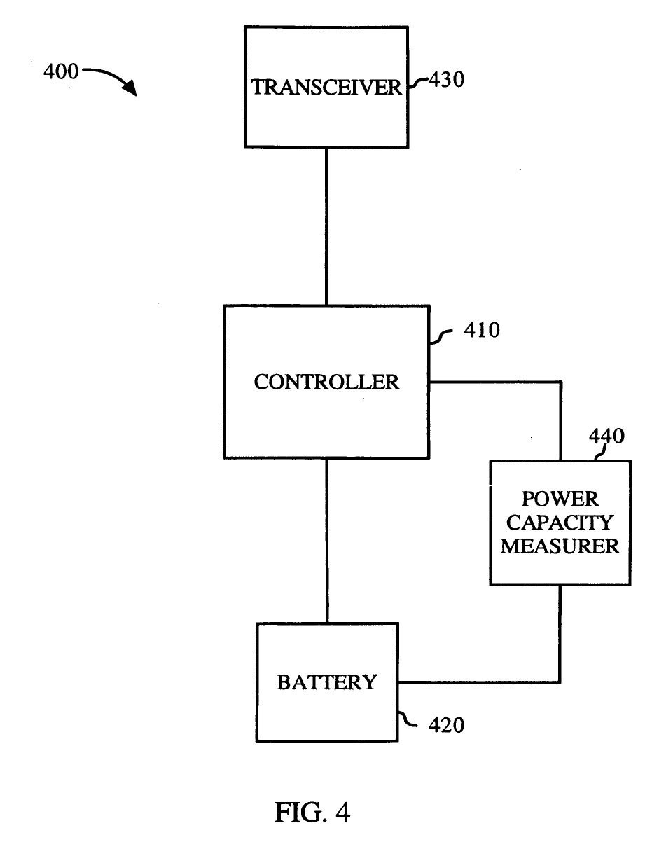

Referring to FIG. 4, a block diagram of a device 400 is shown. Device 400 may be representative of receiving device 320 of FIG. 3. Device 400 may refer to any type of telecom device. Device 400 may include a phone, a cordless phone, a personal digital assistant, a personal computer, a cellular phone, Wi-Fi phones, Wi-Max phones and the like. Device 400 may be operable with session initiation protocol (SIP). SIP may refer to an application-layer control protocol operable for Internet telephony. Device 400 may include a controller 410, a power storage device, such as a battery 420, a transceiver 430 and a power capacity measurer 440. Controller 410 may include a processing unit and operating software to control operation of device 400. Battery 420 may supply power to processing unit. Transceiver 430 may be a combination transmitter/receiver and may operate according to full duplex mode configured for simultaneous transmission and reception of communication signals.

Power capacity measurer 440 may determine a power capacity of battery 420. Power capacity measurer 440 may include battery voltage monitoring and may produce a percentage of power capacity, such a portion of available voltage from full capacity. Power capacity measurer 440 may be configured to calculate drained power and may include battery gage meter circuits. Available power may be presented as a percentage of full power, a voltage, an operating time and the like. It is contemplated that other ways of determining available power may be utilized without departing from the scope and intent of the present disclosure. It is further contemplated that controller 410 may calculate an estimated remaining operating time for the device 400 without a re-charge or change of a power source, such as a battery 420. Estimated operating time may be in the form of a number of hours, minutes or seconds, or a combination of hours, minutes and seconds. The estimated remaining operating time may change over time, for example, the estimated operating time may increase if a battery is being re-charged. An estimated operating time may decrease after extended usage, such as a long phone call. Additionally, transceiver 430 may be capable of transmitting the estimated operating time across a wireless network which may be utilized by a communication network to effectively route communication traffic.

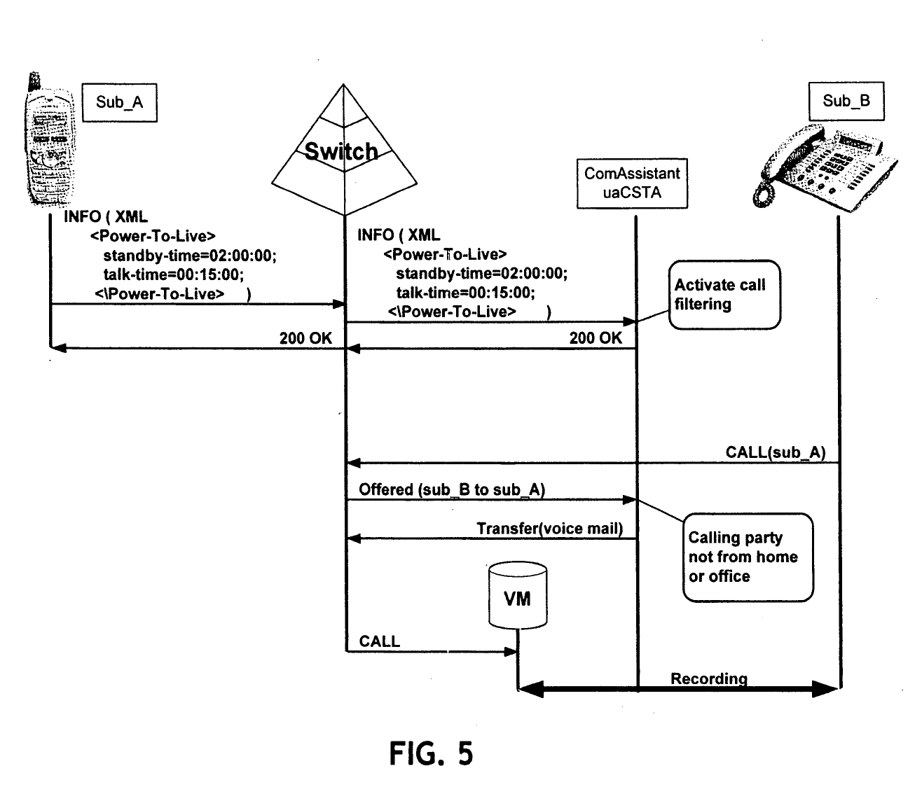

Referring to FIG. 5, exemplary operation of a system for managing communication traffic based upon available power for a device is shown. A wireless (Wi-Max) SIP phone may detect a low battery state (a low available power condition) and may calculate an estimated operating time of two (2) hours. The available power information may initiate an “INFO” message to a Call-Center-Assistant or to a Communication-Assistant manager (using, for example, user agent computer-supported telecommunications applications (uaCSTA)) which may refer to a software client application controlling the SIP phone in parallel. User agent computer-supported telecommunications applications may refer to an interface and may be a software application with typically an SIP and XML based interface. Communication-Assistant may refer to a third party call control (3PCC) application, which manages incoming and outgoing calls for a phone or other communication device.

The SIP message with header may be:

Power-To-Live : standby-time=02:00:00 ; talk-time=00:15:00

and XML body with PTL value

```
  ....
  < Power-To-Live>
```

standby-time=02:00:00;
talk-time=00:15:00;

<\ Power-To-Live>
....

The SIP message may be sent to the switch and to the Corn-Assistant. In the receiving soft-switch, the SIP portion of this message may be understood but since it does not hit any of the setup thresholds in the soft-switch, no action may be initiated. When the uaCSTA Corn-Assistant receives and evaluates the XML portion of this message, a threshold may be achieved. The Com-Assistant may activate an alarm on its display and may route the incoming calls for the SIP-phone differently based upon the low power state (below an available power threshold).

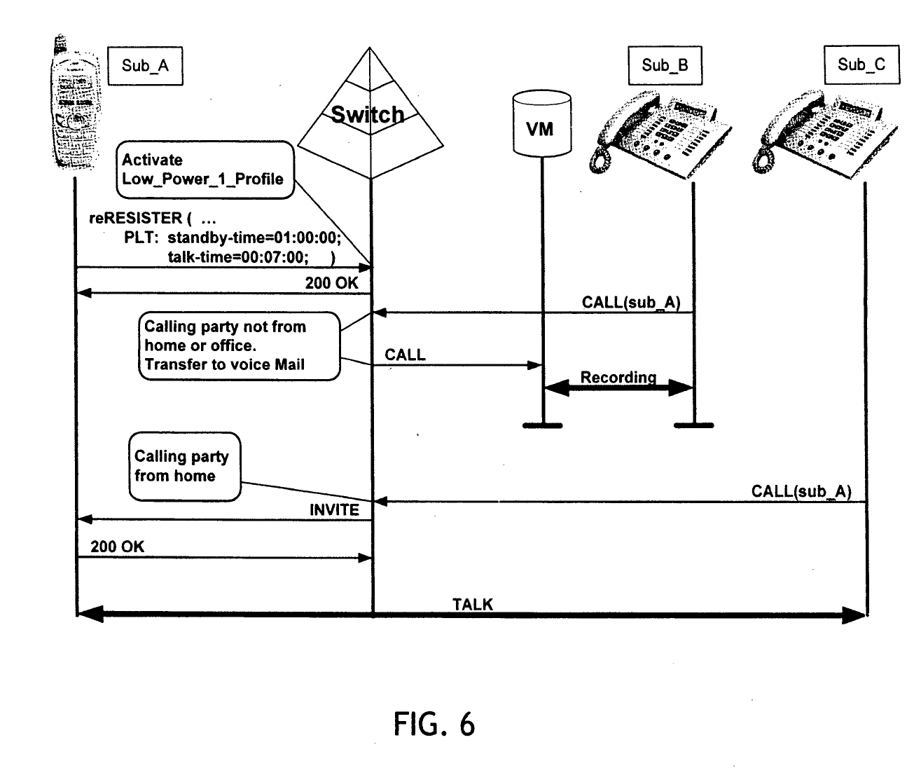

Referring to FIG. 6, exemplary operation of an alternative system for managing communication traffic based upon available power for a device is shown. A wireless (Wi-Max) SIP-phone may detect a low battery state. The device in its regular “re-Registration” with a switch, may send a SIP message “REGISTER” message with an indication that the SIP phone device has a short time to operate (a low available power condition).

Power-To-Live: standby-time=01:00:00; talk-time=00:07:00

The power-to-live value may be below an available power threshold in the soft-switch. The soft-switch may activate a previously setup profile “Low_Power_Level_{—}1_profile”, which may redirect all calls other than from home and from work place to a message buffer, such as Voicemail.

While particular embodiments of the subject matter of this application have been shown and described, it will be obvious to those skilled in the art that, based upon the teaching herein, changes and modifications may be made without departing from the subject matter and its broader aspects and, therefore, the appended claims are to encompass within their scope all such changes and modifications as are within the true spirit and scope of the subject matter. Furthermore, it is to be understood that the subject matter of this application is solely defined by the appended claims.

1. A method for managing communication traffic, comprising: receiving available power information from a device; detecting a communication intended for the device; determining a source of said communication intended for the device; and routing said communication intended for the device based upon said available power information of said device and said source of said communication intended for the device.

2. The method as claimed in claim 1, wherein said available power information includes an estimated operating time for the device.

3. The method as claimed in claim 1, wherein said communication is at least one member of the group consisting of a phone call, text message and electronic mail message.

4. The method as claimed in claim 1, wherein said determining a source of said communication intended for the device includes receiving a caller identification.

5. The method as claimed in claim 1, wherein said determining a source of said communication intended for the device includes receiving an electronic mail address.

6. The method as claimed in claim 1, wherein said communication is routed to at least one member of the group consisting of the device and a message buffer based upon said available power information of said device and said source of said communication intended for the device.

7. The method as claimed in claim 6, wherein said communication is routed to said device when said available power of said device is above an available power threshold.

8. The method as claimed in claim 6, wherein said communication is routed to said device when said available power of said device is below an available power threshold and said source is a first calling device.

9. The method as claimed in claim 6, wherein said communication is routed to said message buffer when said available power of said device is below an available power threshold and said source is a second calling device.

10. A method for managing communication traffic, comprising: receiving available power information from a device; determining that said device has available power greater than an available power threshold; routing a first communication intended for the device to the device; receiving available power information from said device; determining that said device has available power less than said available power threshold; detecting a second communication intended for the device; determining a source of said second communication intended for the device; and routing said second communication intended for the device based upon said source of said communication intended for the device.

11. The method as claimed in claim 10, wherein said available power information includes an estimated operating time for the device.

12. The method as claimed in claim 10, wherein said first communication and said second communication are selected from at least one member of the group consisting of a phone call, text message and electronic mail message.

13. The method as claimed in claim 10, wherein said determining a source of said second communication intended for the device includes receiving a caller identification.

14. The method as claimed in claim 10, wherein said determining a source of said second communication intended for the device includes receiving an electronic mail address.

15. The method as claimed in claim 10, wherein said second communication is routed to at least one member of the group consisting of the device and a message buffer based upon said source of said second communication intended for the device.

16. The method as claimed in claim 15, wherein said second communication is routed to said device when said source is a first calling device.

17. The method as claimed in claim 15, wherein said second communication is routed to said message buffer when said source is a second calling device.

18. A system for managing communication traffic, comprising: a calling device; a receiving device; and a communication network, said communication network being operatively coupled to said calling device and said receiving device, said communication network being configured for receiving available power information of said receiving device and routing communication intended for said receiving device based upon said available power information of said receiving device and an identity of said calling device.

19. The system as claimed in claim 18, wherein said communication network includes at least one member of the group consisting of a cellular network and an internet telephony network.

20. The system as claimed in claim 18, wherein said receiving device is at least one member of the group consisting of a mobile computing device, cellular phone, wireless device, cordless device or mobile phone.

21. The system as claimed in claim 18, wherein said available power information includes an estimated operating time.

22. An apparatus for wireless communication, comprising: a controller, a transceiver coupled to said controller; a battery coupled to said controller; and a power capacity measurer, said power capacity measurer coupled to said battery, said power capacity measurer configured for determining a power capacity of the battery, said controller determining an estimated operating time for the apparatus, said transceiver transmitting said estimated operating time of said apparatus through a wireless network.
